(19) United States
(12) Patent Application Publication
(10) Pub. No.: US 2005/0035955 A1
(43) Pub. Date: Feb. 17, 2005

(54) Method of determining orientation and manner of holding a mobile telephone

(76) Inventors: Dale J. Carter, Orem, UT (US); Richard Woolley, Orem, UT (US); Wayland M. Duncan, Tooele, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/798,240

(22) Filed: Mar. 11, 2004

Related U.S. Application Data
(63) Continuation-in-part of application No. 10/165,182, filed on Jun. 6, 2002.
(60) Provisional application No. 60/454,012, filed on Mar. 12, 2003.

(51) Int. Cl. H04M 1/00; H04Q 7/20; G09G 5/00

(52) U.S. Cl. 345/175

(57) ABSTRACT

A mobile telephone that is being held in the hand of a user, wherein sensors within the mobile telephone are able to determine orientation of the mobile telephone, and determination where on a mobile telephone a user is making contact, wherein the orientation and contact information is used to enable and disable desired functions of the portable electronic appliance.

### CROSS REFERENCE TO RELATED APPLICATIONS

This document claims priority to, and incorporated by reference all of the subject matter included in the provisional patent application docket number 2635.CIRQ.PR, having Ser. No. 60/454,012 and filed on Mar. 12, 2003. This document also claims priority to and is a continuation-in-part of the co-pending patent application Ser. No. 10/165,182 and filed on Jun. 6, 2002.

### BACKGROUND OF THE INVENTION

1. Field of the Invention

This invention
relates generally to touchpads and portable electronic appliances. More specifically, the invention relates to the use of a portable electronic appliance such as mobile telephones, cameras, global positioning devices (GPS), camcorders, personal digital assistants (PDA), and devices that incorporate more than one feature, wherein these devices incorporate touchpad technology for data entry or control of the portable electronic appliance.

2. Background of the Invention

Portable electronic appliances include portable communication devices known by many popular names such as cellular telephones, cell phones, and mobile telephones (hereinafter referred to collectively as “mobile telephones”) to name a few. Mobile telephones are now capable of providing more services than just voice transmission. For example, mobile telephones now provide data services such as access to the Internet for web browsing and for using email. These services are becoming ubiquitous as the infrastructure to provide them is becoming more widely available.

There are several problems that inhibit use of these data services. Because these mobile telephones are small devices, there is a lack of surface space on them in which to implement data entry and control technologies. A mobile telephone must typically rely on the keypad as the main source of alphanumerical data input and display control. Unfortunately, experience has shown that using the keypad for all types of data entry and control is inefficient, slow, cumbersome, and frustrating to the user. Thus, while the ability to easily navigate a graphical interface such as a mobile telephone web browser and to rapidly enter text in a word processor in order to send email is highly desirable, it is unfulfilled.

Mobile telephones have now had features of other portable electronic appliances incorporated in them, or telephone features are incorporated in other portable electronic appliances. The lines determining the primary function of these devices has become blurred as performance of all the functions are improved. Accordingly, the present invention applies to any portable electronic appliance, whether it is dedicated to a single function, or combines more than one function in a single device.

Therefore, it would be an advantage over the state of the art in the operation and control of portable electronic appliances to provide new methods of activating and deactivating functions, wherein the new methods are more intuitive and natural to operation of the desired device.

FIG. 1 is provided as a perspective view of a prior art mobile telephone 10 that does not use folding or unfolding action to activate or deactivate the mobile telephone. The dotted line indicates the approximate location of a touchpad 12 that is disposed underneath a plurality of keys 14. The plurality of keys 14 are the only visible portion of a keymat (not shown) disposed underneath a hard housing 16. The keymat is the first layer of a keypad 18. The keypad 18 includes all of the components that enable the plurality of keys 14 to actuate corresponding mechanical switches, and in this invention, also includes the touchpad 12 which is integrally disposed therein. The mobile telephone 10 includes a display screen 20, and may also include an external antenna (not shown). Inside the mobile telephone 10 is disposed a power source such as a rechargeable battery, and the electronic circuitry for the mobile telephone and for the touchpad 12.

In this example of the prior art, the touchpad 12 is from the GLIDEPOINT™ or GLIDESENSOR™ technology of CIRQUE™ Corporation. This touchpad technology provides a flexible substrate for the sensor grids of a capacitance sensitive touchpad. The flexible substrate is not only capable of conforming to arcuate surfaces, such as the underside of the keymat, it is also capable of being slight deformed. This feature of the touchpad enables the touchpad to be disposed along curved surfaces.

The touchpad 12 provides another capability that is critical to successful operation of the touchpad in the mobile telephone 10. The touchpad 26 is cable of providing both touch and proximity sensing. Proximity sensing is the ability to detect a pointing object that is not in direct contact with the surface of the touchpad 12. Proximity sensing is thus the ability to detect a pointing object, in this case a finger, without direct contact with a sensing surface of the touchpad 12.

Cirque™ Corporation touchpad technology is uniquely suited to provide this enhanced z-axis proximity sensing capability. Essentially, the increased dynamic range of the touchpad is provided by the integrated circuit at the heart of the touchpad circuitry. The increased dynamic range is made possible for several underlying reasons. These reasons include not having to throw away the smallest measurement bits because a more accurate analog-to-digital (A/D) converter is being used. More specifically, it was determined that the noise within an A/D converter itself was responsible for having to throw away measurement data that could not be considered reliable. Thus, the techniques used for electronic noise reduction within the touchpad circuitry result in substantial improvement in performance.

Another factor for improved performance of the touchpad 12 is an unexpected result which came about as a consequence of the A/D converter mentioned above. Specifically, the number of measurement readings or “sampling” taken by the measurement circuitry could be doubled to thereby cause a decrease in the noise of the A/D converter.

Together, the decreased noise of the A/D converter and the two-fold increase in the number of samples of the measurement circuitry have combined to create at least a four-fold increase in accuracy of the touchpad sensing circuitry.

Another factor is that the present invention utilizes Cirque™ capacitance sensing technology. One particular advantage of this technology is that the electrode grid comprised of separate X and Y electrodes, and taught in Cirque™ Corporation U.S. Pat. Nos. 5,305,017, 5,565,658, and 5,861,875, is that the technology does not depend upon having a well established earth ground. Mutual capacitance enables detection of a finger changing the capacitance between the X and Y electrodes. An earth ground is not important in its measurement methodology. Thus, the increase in touchpad sensitivity combined with the advantages of mutual capacitance technology enable the Cirque™ touchpad to accomplish accurate proximity sensing.

### BRIEF SUMMARY OF THE INVENTION

It is an object of the present invention to provide a portable electronic appliance with sensors that enable the physical orientation of the portable electronic appliance to be determined.

It is another object to provide a portable electronic appliance with sensors that enable the determination of where contact is taking place between a user and a portable electronic appliance.

It is another object to provide a portable electronic appliance with sensors that determine orientation and the manner of being held in order to control which functions of the portable electronic appliance can be actuated.

In a preferred embodiment, the present invention is a mobile telephone that is being held in the hand of a user, wherein sensors within the mobile telephone are able to determine orientation of the mobile telephone, and determination where on a mobile telephone a user is making contact, wherein the orientation and contact information is used to enable and disable desired functions of the portable electronic appliance.

In a first aspect of the invention, a plurality of sensors are disposed at various locations in the portable electronic appliance such that contact with or proximity to a user can be determined at various locations of a housing of the portable electronic appliance.

In a second aspect of the invention, the plurality of sensors are touch or proximity sensitive capacitance sensors.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is an illustration of a mobile telephone of the prior art that utilizes a touchpad in order to provide increased functionality.

FIG. 2 is a perspective illustration of a mobile telephone of the present invention that now has a first sensor and a plurality of second sensors that enable determination of the orientation of the mobile telephone, and determination of how the mobile telephone is being held by the user.

FIG. 3A is a first view of a mobile telephone having a plurality of second sensors disposed therein.

FIG. 3B is a second view of a mobile telephone having a plurality of second sensors disposed therein.

FIG. 3C is a third view of a mobile telephone having a plurality of second sensors disposed therein.

FIG. 3D is a third view of a mobile telephone having a plurality of second sensors disposed therein.

FIG. 4 is illustrates the location of certain ones of the plurality of second sensors 34 that function as actuation sensors.

FIG. 5 is an illustration of a flowchart for an algorithm.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is shown as being implemented in a mobile telephone. However, the invention is applicable to any portable electronic appliance described previously, or any other portable electronic appliance that can take advantage of the principles of the present invention. Therefore, the explanation to follow of the principles of the present invention should be considered to be applicable in any portable electronic appliance.

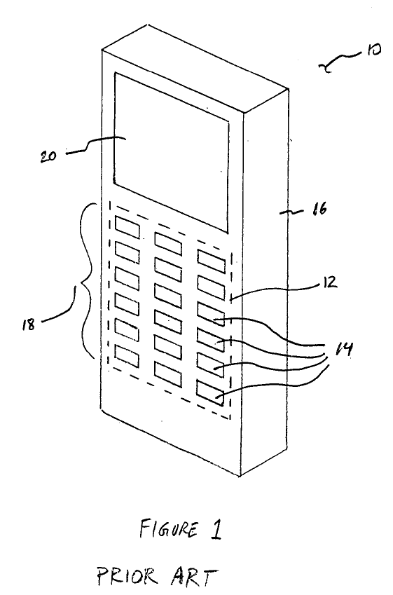

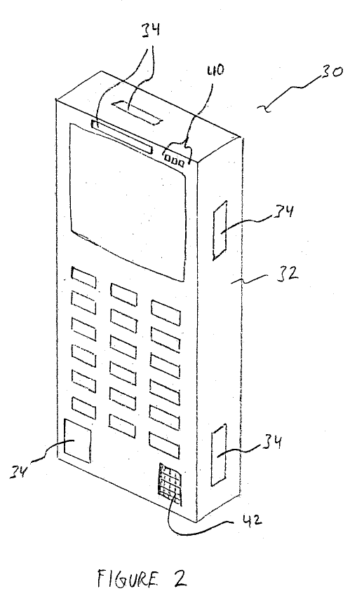

Consider again a mobile telephone such as a cellular telephone that was shown in FIG. 1. FIG. 2 shows a similar mobile telephone 30 that has been modified in accordance with the principles of the present invention. The mobile telephone 30 is shown as having a housing or body 32. The body 32 in this case is an elongated structure that lends itself to being held by a hand, and is not flipped open or shut as other mobile telephone designs. A first sensor (not shown) is disposed within the body 32. A plurality of second sensors 34 are disposed at various strategic locations on or just under the surface of the body 32. The strategic locations are selected to enable the plurality of second sensors 34 to determine how the mobile telephone 10 is being held, or what parts of the mobile telephone are in contact with the body of the user.

The first sensor (not shown) within the mobile telephone 30 can determine the orientation thereof. In other words, the first sensor determines if the mobile telephone 30 is upright, upside down, face up, face down, horizontal, vertical, or any other incremental orientation or a combination of these orientations. A first sensor that is capable of making these determinations is well known to those skilled in the art of sensor technology. For example, the magnetic sensors described in co-pending application Ser. No. 10/158,592 can be used for this purpose.

There are several reasons for determining orientation of the mobile telephone 30 by using the first sensor. Not all of these reasons have particular application to a mobile telephone 30. For example, the mobile telephone 30 in which the present invention is being used may be able to provide a user with directional information. For example, if the mobile telephone 30 includes GPS capabilities, it may also function as an electronic compass. Some GPS devices also provide the ability to direct a user to a desired location that has been programmed into a GPS database. By holding a display screen of the mobile telephone 10 in a face up position and relatively horizontal position, a direction indicator on a display screen can point from the user's current location to the desired location.

This example should not be considered to be limiting. There may be other applications where specific orientation of a portable electronic appliance can provide useful information to the user.

The mobile telephone 30 also includes a plurality of second sensors 34 that are different in their sensing capabilities from those of the first sensor. The plurality of second sensors 34 are used to determine how the portable electronic appliance is being held. In other words, it is possible to determine where the mobile telephone 30 is being touched or held by the user.

By understanding where the mobile telephone 30 is being touched or held, it is then possible to provide enhanced ease of use and increased functionality to a user that becomes intuitive. For example, assumptions can be made as to how the mobile telephone should operate simply based upon how it is being held, or how it is not being held, or the nature of the transition between being held and not being held.

For example, consider one of the plurality of second sensors 34 that is disposed near a primary speaker 40 that is typically held against the user's ear when listening to the primary speaker. In this way, the plurality of second sensors 34 can determine if the user is holding the mobile telephone against the user's ear and using the mobile telephone in a typical primary speaker mode.

In contrast, consider the situation where the user is operating the mobile telephone 30 in a speakerphone mode, wherein a speakerphone 42 is used to generate sound that is audible to anyone who is near the mobile telephone 30. If the user picks up the mobile telephone 30 and places it against an ear, the mobile telephone can turn off the speakerphone 42, and begin to automatically transmit sound through the primary speaker 40 that is now disposed near the user's ear, without having to press a button or activate a switch to change from the speakerphone mode to the primary speaker mode.

Another example of how the plurality of second sensors 34 can be used is the situation when the user wants to indicate by simple actions an intent to use or discontinue use of the mobile telephone 30. For example, touching a certain location on the body 32 of the mobile telephone 30 can indicate that the mobile telephone should be turned off, turned on, volume should be increased, volume should be decreased, or that a speakerphone should be activated or deactivated.

For example, when the user grips the mobile telephone 30 in a manner that indicates it is going to be held up to the user's ear and operated through the primary speaker 40, the mobile telephone is activated. Similarly, when the mobile telephone 30 is subsequently removed from contact with or proximity to the user's ear, then the mobile telephone will terminate a call in progress.

Any actions that can be activated or deactivated in accordance with data received from the plurality of second sensors 34 can be modified, for example, by initiating a timing sequence so that a call in progress is not terminated until the mobile telephone has been removed from contact with or proximity to the user's ear for a pre-determined amount of time. The timing sequence therefore prevents accidental actions from being performed that the user does not want to happen.

It should be noted that the specific shape of the mobile telephone 30 is not a critical element of the present invention, nor the locations given for the various speakers 40, 42. What is important to the present invention is that any portable electronic appliance can be modified to include the first sensor and the plurality of second sensors in locations that will enable the portable electronic appliance to take advantage of the principles of the present invention. Thus, the shape of the mobile telephone can modified to reflect the many different designs on use in the market today, including the flip-phone design.

The present invention is implemented using a plurality of contact and/or proximity-based capacitance sensitive touchpads that use Cirque™ Corporation GLIDEPOINT™ or GLIDESENSOR™ technology for the plurality of second sensors 34. The advantage of the capacitance sensitive touchpads, other than the fact that they operate well in the environment of portable electronic appliances that may not be well grounded, is that the plurality of second sensors 34 can be disposed on the inner arcuate surfaces of the body 32 of the mobile telephone 30. If the plurality of second sensors 34 are disposed on the surface of the body 32, then their location is readily apparent. If the plurality of second sensors 34 are disposed under the surface of the body 32, then the locations of the plurality of second sensors can be indicated on the surface of the body 32 through outlines, coloration, texturing, or other tactile or visual means.

It should be apparent that while the present invention implements the plurality of second sensors 34 using Cirque™ touchpad technology, the sensors can incorporate other sensing technologies that will enable determination of where a user is in contact with the mobile telephone 30.

Strategic placement of the plurality of second sensors 34 is important because this determines when functions will be activated and deactivated simply be how the mobile telephone is touched or held. For example, the sides, rear top, rear bottom or other areas of a handheld portable electronic appliance can be used to determine how a single hand is grasping the device. If the portable electronic appliance is too large for a single hand or requires a specific manner of grasping, then placement of the plurality of second sensors 34 provides very useful information for any algorithm that is determining what functions to control.

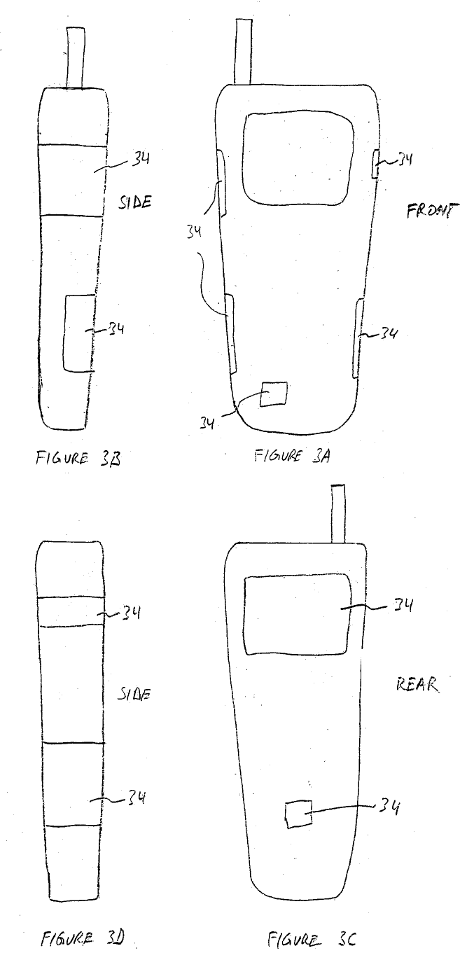

FIGS. 3A, 3B, 3C, and 3D are provided to illustrate possible locations for disposing the plurality of second sensors 34 in the mobile telephone 30. These locations are only illustrative examples that show the plurality of second sensors 34 can be of various shapes and locations.

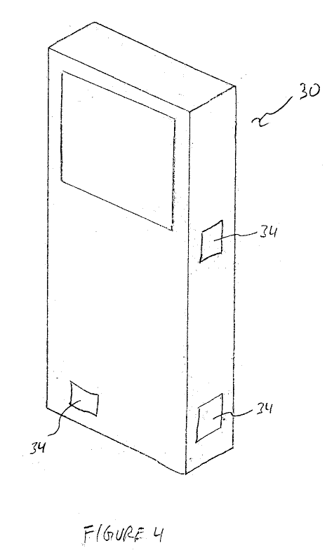

FIG. 4 is provided to illustrate the location of certain ones of the plurality of second sensors 34. Specifically, the plurality of second sensors 34 shown are all actuation sensors. In other words, unless a user is in simultaneous contact or in proximity to the plurality of second sensors 34, then certain functions or features will not be activated or deactivated as the case may be.

Consider an algorithm that is used to determine which functions should be activated or deactivated on the mobile telephone 30. Unless a hand is grasping the mobile telephone 30 so as to be in contact with a particular one or a set of the plurality of second sensors 34, then desired functions will not be activated or deactivated. For example, a finger or thumb may need to be in a certain location on the mobile telephone 30 for the mobile telephone to actuate a speakerphone mode.

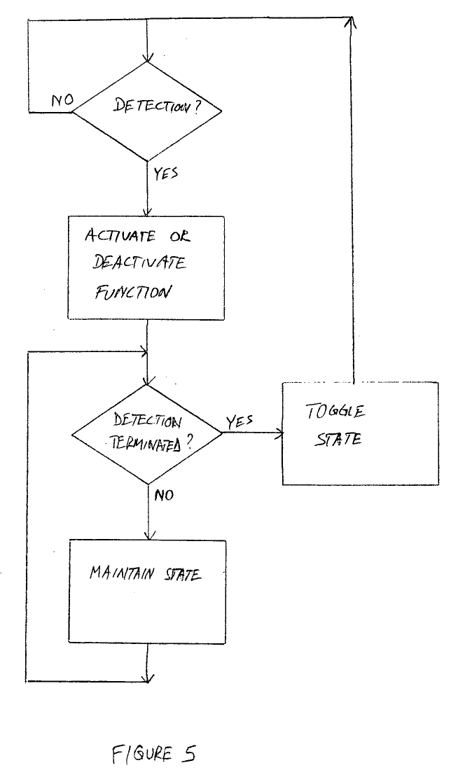

As an example, consider the algorithm illustrated in FIG. 5. In FIG. 5, the algorithm sites in a loop until detection of the user against a particular set of the plurality of second sensors 34. Once detection has occurred, a particular function is either activated or deactivated. The function remains activated or deactivated until the algorithm determines that contact with the particular set of the plurality of second sensors 34 is terminated.

Alternatively, a timing sequence can be inserted into the algorithm so that the function is not terminated or activated until contact has been broken for a predetermined length of time.

The Cirque™ Corporation general purpose touchpad technology of multi-layer touchpads is not the only type of capacitance sensitive touchpads that can be used in the present invention. Because the touchpad only has to determine touch or proximity, and not location of the touch on the touchpad, a single-layer touchpad technology can also be used to reduce costs of the touchpads in the portable electronic appliance.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

1. A portable electronic appliance comprising:
a portable electronic appliance having a housing, a data entry device and a display screen;
at least one second sensor disposed on a surface of the housing such that a user can make physical contact with the at least one second sensor; and
wherein the at least one second sensor provides contact data to a sensor circuit disposed within the portable electronic appliance, wherein the contact data in the sensor circuit is utilized by a processor within the portable electronic appliance to determine whether or not to activate or deactivate a predetermined function of the portable electronic appliance.

2. The portable electronic appliance as defined in claim 1 wherein the portable electronic appliance is selected from the group of portable electronic appliances comprised of a laptop computer, a mobile telephone, a personal digital assistant, a global positioning system, an electronic compass, a camera, a camcorder, and combination devices that include at least two of the functions above.

3. The portable electronic appliance as defined in claim 1 wherein the at least one second sensor is comprised of a capacitance sensitive touchpad.

4. The portable electronic appliance as defined in claim 1 wherein the at least one second sensor is selected from the group of sensors comprised of pressure sensitive, electrostatic, and any other sensing technology that enables detection of contact of a user on the at least one second sensor.

5. The portable electronic appliance as defined in claim 3 wherein the capacitance sensitive touchpad is capable of conforming to arcuate surfaces.

6. The portable electronic appliance as defined in claim 3 wherein the capacitance sensitive touchpad is capable of sensing touch.

7. The portable electronic appliance as defined in claim 3 wherein the capacitance sensitive touchpad is capable of proximity sensing.

8. The portable electronic appliance as defined in claim 3 wherein the at least one second sensor is comprised of a plurality of capacitance sensitive touchpads.

9. The portable electronic appliance as defined in claim 1 wherein the at least one second sensor is comprised of at least one general purpose touchpad that can sense position as well as touch or proximity of a touching object to the touchpad.

10. The portable electronic appliance as defined in claim 1 wherein the at least one second sensor is comprised of at least one single-layer touchpad that can sense touch or proximity of a touching object to the touchpad.

11. The portable electronic appliance as defined in claim 1 wherein the portable electronic appliance is further comprised of a first sensor, wherein the first sensor is capable of determining orientation of the portable electronic appliance.

12. The portable electronic appliance as defined in claim 1 wherein the functions that can be activated or deactivated using the at least one second sensor are selected from the group of functions comprised of turning on, turning off, increasing volume, decreasing volume, engaging a speakerphone mode, disengaging a speakerphone mode, toggling from a first function to a second function, and toggling from a second function back to a first function.

13. A portable electronic appliance comprising:
a portable electronic appliance having a housing, a data entry device and a display screen;
at least one second sensor disposed underneath a surface of the housing such that a user is detected using proximity sensing capabilities of the at least one second sensor; and
wherein the at least one second sensor provides proximity sensing data to a sensor circuit disposed within the portable electronic appliance, wherein the proximity sensing data in the sensor circuit is utilized by a processor within the portable electronic appliance to determine whether or not to activate or deactivate a predetermined function of the portable electronic appliance.

14. A method for determining where a user is touching a portable electronic appliance, said method comprising the steps of:
1) providing a housing, a data entry device and a display screen for the portable electronic appliance;
2) providing at least one second sensor disposed on a surface of the housing such that a user can make physical contact with the at least one second sensor; and
3) wherein the at least one second sensor provides contact data to a sensor circuit disposed within the portable electronic appliance, wherein the contact data in the sensor circuit is utilized by a processor within the portable electronic appliance to determine whether or not to activate or deactivate a predetermined function of the portable electronic appliance.

15. The method as defined in claim 14 wherein the step of providing the portable electronic appliance is further comprised of selecting the portable electronic appliance from the group of portable electronic appliances comprised of a laptop computer, a mobile telephone, a personal digital assistant, a global positioning system, an electronic compass, a camera, a camcorder, and combination devices that include at least two of the functions above.

16. The method as defined in claim 14 wherein the step of providing the at least one second sensor is further comprised of providing a capacitance sensitive touchpad.

17. The method as defined in claim 14 wherein the step of providing the at least one second sensor is further comprising of selecting the at least one second sensor from the group of sensors comprised of pressure sensing, electrostatic sensing, and any other sensing technology that enables detection of contact of a user on the at least one second sensor.

18. The method as defined in claim wherein the method further comprises the step of conforming the capacitance sensitive touchpad to arcuate surfaces of the portable electronic appliance.

19. The method as defined in claim 16 wherein the method is further comprised of the step of providing a capacitance sensitive touchpad that is capable of sensing touch.

20. The method as defined in claim 16 wherein the method is further comprised of the step of providing a capacitance sensitive touchpad that is capable of proximity sensing.

21. The method as defined in claim 16 wherein the method of providing at least one second sensor is further comprised of the step of providing a plurality of capacitance sensitive touchpads.

22. The method as defined in claim 14 wherein the method of providing the at least one second sensor is further comprised of the step of providing at least one general purpose touchpad that can sense position as well as touch or proximity of a touching object to the touchpad.

23. The method as defined in claim 14 wherein the method of providing the at least one second sensor is further comprised of providing at least one single-layer touchpad that can sense touch or proximity of a touching object to the touchpad.

24. The method as defined in claim 14 wherein the method further comprises the step of providing a first sensor, wherein the first sensor is capable of determining orientation of the portable electronic appliance.

25. The method as defined in claim 14 wherein the step of providing functions that can be activated or deactivated using the at least one second sensor are selected from the group of functions comprised of turning on, turning off, increasing volume, decreasing volume, engaging a speakerphone mode, disengaging a speakerphone mode, toggling from a first function to a second function, and toggling from a second function back to a first function.
